(19) United States
(12) Patent Application Publication
(10) Pub. No.: US 2008/0254688 A1
(43) Pub. Date: Oct. 16, 2008

(54) Electronic component socket and methods for making and using the same

(76) Inventors: Robert Bogursky, Encinitas, CA (US); Kenneth Krone, San Diego, CA (US); Leonid Foshansky, San Diego, CA (US)

Correspondence Address: Robert F. Gazdzinski;Suite 375, 11440 West Bernardo Court, San Diego, CA, 92127, US

(21) Appl. No.: 12/072,607

(22) Filed: Feb. 26, 2008

Related U.S. Application Data
(60) Provisional application No. 60/903,683, filed on Feb. 26, 2007.

(51) Int. Cl. H01R 13/11; H01R 43/16

(52) U.S. Cl. 439/858; 29/874

(57) ABSTRACT

A socket or clip adapted to provide an interconnect between an electronic component, such as an automotive blade fuse, and a printed circuit board or other device. The clip comprises a substantially unitary structure for attaching the electronic component to the printed circuit board substrate. In one embodiment, the clip also comprises a closed-entry structure receiving element to receive the electronic component; a terminating element for interfacing the clip to the printed circuit board; a spring clip element for receiving terminations from said electronic component; and an overstress feature for preventing the spring clip element from becoming overstressed.

### PRIORITY

This application claims priority to co-owned U.S. patent provisional application Ser. No. 60/903,683 filed Feb. 26, 2007 and entitled “Electronic Component Socket and Methods for Making and Using the Same”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE INVENTION

The present invention relates generally to the area of electronic socket technology as it applies to the field of electronic components, and more specifically in one embodiment to so-called blade fuse socket or clip technology.

### 2. DESCRIPTION OF RELATED TECHNOLOGY

The present invention relates to electronic component clip technology and specifically to applications involving electrical or electronic components, such as for example so-called “blade fuse” clip technology, common in such industries as the automobile industry. Electronic component clips are widely used for interconnecting electronic components into an electronic circuit. A myriad of approaches have been utilized to facilitate the prevalence and universality of clip technology.

For example, U.S. Pat. No. 3,960,435 to Bailey, et al. issued on Jun. 1, 1976 and entitled “Cartridge fuse clip with rejection means” discloses a fuse clip which accepts and retains the annularly grooved end cap of a current limiting ferrule cartridge fuse inserted therein, and which rejects the insertion of other classes of ferrule cartridge fuses using the annularly grooved end cap. The fuse clip of the invention includes a central mounting portion and a pair of arm members extending in like direction from opposite sides of the mounting portion. The arm members include rejection means positioned on each arm member to co-act with the annular groove in the current limiting fuse end cap and allow it to be inserted and retained in the clip. The rejection means prevents the seating of a conventional fuse end cap in the clip and exerts a force on the cap tending to push it out of the clip.

U.S. Pat. No. 4,059,334 to Bailey issued on Nov. 22, 1977 and entitled “Blade type fuse clip assembly” discloses a fuse clip assembly for receiving and retaining one end of a blade type fuse. The assembly includes an inexpensively produced extruded electrically conductive member which includes both, an improved fuse blade contact surface, and a terminal connector. The assembly also includes a resilient member which presses a fuse blade inserted in the assembly against the contact surface on the extruded member for improved electrical surface contact therewith. Since the terminal connector and electrical contact surface are integrally formed in one member. The resilient member can be made of a dielectric material.

U.S. Pat. No. 4,084,146 to Baumann issued on Apr. 11, 1978 and entitled “Fuse assembly” discloses a fuse assembly having a dielectric base plate and a fuse strip laminated to the base plate. The fuse strip comprises a bus bar and one or more spaced contact portions each joined by a fuse link to the bus bar. At the end of each fuse link the laminate is apertured to receive a fuse clip. The fuse clip is insertable in the aperture and is constructed and arranged to have clamping engagement with the base plate and fuse strip. The fuse clips associated with each fuse link are provided with aligned fuse retention means adapted to receive a substitute fuse link device for electrically bypassing an open fuse link in the fuse strip.

U.S. Pat. No. 4,099,828 to Stegmaier, et al. issued on Jul. 11, 1978 and entitled “Blade-type fuse clip with field installable rejection means” discloses a fuse clip that includes a pair of clamping arms defining a fuse terminal blade receiving slot. A rejector pin, once inserted through a hole in one of the clamping arms, is prevented from being withdrawn by a spring retainer clip. The pin, which spans the slot to accept only fuse terminal blades keyed with a special notch, carries a loaded compression spring serving to rigidify its cantilever mounting to the one clamping arm.

U.S. Pat. No. 4,178,063 to Reynolds issued on Dec. 11, 1979 and entitled “Rejection type fuse clip assembly” discloses a fuse clip assembly that includes opposed clamping arms defining a pocket for receiving a fuse terminal ferrule. A rejection member, secured in operative relation with the fuse clip, includes a body arranged transversely of the pocket beyond the clip and three rejector arms extending from the body toward the clip. Two of the rejector arms are situated in opposed, spaced relation immediately above the pocket, while the third rejector arm is situated between the clamping arms beneath the pocket. The arms carry interference portion to obstruct the path of downward or endwise insertion into the pocket of a fuse ferrule not specially keyed with an annular groove.

U.S. Pat. No. 4,214,801 to Cairns, et al. issued on Jul. 29, 1980 and entitled “Fuse holder with insertion ramp” discloses an automobile terminal block for receiving fuses, and electrical connections to various electrical components of the automobile. The terminal block has a passage which has therein a fuse holder mounted within the terminal block. The fuse holder receives the blade contact of a fuse thereby establishing an electrical connection to the fuse. The fuse holder has a spring clip with two prongs spring biased against one another so that a blade contact can be resiliently secured between the two prongs. The fuse holder is inserted into the terminal block and has an opening therein for receiving a protrusion extending into the passage where the fuse holder is inserted thereby securing the fuse holder to the terminal block. The fuse holder has a ramp attached to each of the prongs for facilitating movement of the prongs over the protrusion so that the protrusion does not engage the prongs and stop the fuse holder from moving into the passage.

U.S. Pat. No. 4,429,936 to Rusenko, et al. issued on Feb. 7, 1984 and entitled “Spring jaw fuse clip and integrally retained fuse puller” discloses a spring jaw fuse clip having a backup spring encircling the fuse clip and bearing inwardly upon the outer surfaces of the legs of the fuse clip, the spring being attached to the fuse clip by engagement of portions thereof with horizontal notches in the edges of the fuse clip legs to prevent displacement of the spring with respect to the clip, and having a insulating fuse puller loop disposed within a pair of slots open to the upper ends of the fuse clip legs for linear movement therein. A rib is provided on the fuse puller loop in the area between the fuse clip legs to prevent tilting or displacement of the fuse puller loop with respect to the fuse clip and to facilitate insertion of the fuse blade therein by camming the legs outwardly to the width of the fuse blade upon being displaced to its outermost position in said clip. A portion of the backup spring extends laterally along one leg of the fuse clip to span the open end of the slot in that leg, thereby to be engaged by the bight portion of the insulating fuse puller loop to limit outward movement of the loop with respect to the fuse clip assembly and thereby to retain the fuse puller integrally assembled therewith.

U.S. Pat. No. 4,500,162 to Keglewitsch, et al. issued Feb. 19, 1985 and entitled “Contact clip apparatus for blade-type contacts” discloses a fuse clip apparatus that provides connecting means for a blade type cartridge fuse in a circuit. The fuse clip includes an extruded terminal connector formed of aluminum or copper. The connector includes a terminal block for connection to an electrical lead. A blade contact portion is generally channel-shaped and includes a flat contact wall on one side of the extruded block and a spaced integral spring support wall. A beam plate spring is integrally formed with, or separately formed and interconnected to, the support wall. The illustrated spring is a double supported convex beam which extends from spaced support portions of the support wall toward the flat contact wall. The blade of the fuse is forced between the convex beam spring and the contact wall to hold the blade in firm engagement with the contact wall.

U.S. Pat. No. 4,722,701 to Bradt issued on Feb. 2, 1988 and entitled “Fuse block for miniature plug-in blade-type fuse” discloses a fuse block for miniature plug-in blade-type fuses comprising a multi-position bussed fuse holder and a plurality of single-connect fuse holders held within a block comprising a floor and a cage. The fuse block features individual terminal boxes for connecting wires to the single-connect fuse holders. The fuse block is expandable by adding one or more floor extensions, additional single-connect fuse holders, a longer bussed fuse holder, and one or more additional cages.

U.S. Pat. No. 4,798,546 to Herbert issued on Jan. 17, 1989 and entitled “Bifurcated fuse clip” discloses a novel fuse holder for a fuse as described for a fuse of the type having two generally flat, parallel spaced apart, oppositely disposed electrical contacts. The fuse holder comprises an insulating block and a fuse clip which is formed from a single strip of electrically conducting material and which is carried within the fuse block. The fuse clip features an elongated base member, a pair of spaced apart arms joined to one end of the base member, and a pair of springingly loaded, generally elongated, bifurcated fuse accepting contacts. Each fuse accepting contact is comprised of a flat fuse contacting section and a flat fuse accepting section.

U.S. Pat. No. 5,328,392 to Lin, et al. issued on Jul. 12, 1994 and entitled “Fuse clip assembly” discloses a junction box assembly that includes a housing having a base member and a cover member, a plurality of retaining members formed on an upper surface of the base member, and a plurality of elastic fuse clips mounted in respective retaining members. Each fuse clip is provided with a pair of opposing clamping portions which releasably and grippingly receive a prong of a fuse. The sidewalls of the retaining members limit the elastic deformation of the clamping portions.

U.S. Pat. No. 5,519,586 to Byrd issued on May 21, 1996 and entitled “Fuse holder assembly having improved fuse clips for mounting on a printed circuit board” discloses a fuse holder assembly that has a pair of fuse clips which provide electrical connection between a fuse and a circuit on a printed circuit board. The fuse holder assembly securely holds a fuse adjacent to an edge of the printed circuit board and in spaced relation to the printed circuit board for easy access to the fuse and for maximizing the area on the printed circuit board available for circuit components or edge connector contacts. Each fuse clip has a mounting base for mounting to the printed circuit board and for providing electrical connection with the circuit on the printed circuit board, and a retention clip attached to the mounting base. A support supports the retention clip and provides access to the retention clip for installation and removal of a fuse within the retention clip. The support limits the movement of the retention clip with respect to the printed circuit board, while allowing resilient deformation of the clip for receiving and releasing a fuse.

U.S. Pat. No. 5,631,619 to Evans issued on May 20, 1997 and entitled “Female automotive fuse having fuse clips electrically connected to conductive thermal blocks” discloses a female fuse having a one piece fuse link and thermal mass injection molded around a multi-finger fuse clips. The fuse link, thermal mass, and fuse clip are enclosed in an insulating housing. The resulting fuse is smaller in size and operates at a cooler temperature than other fuses.

U.S. Pat. No. 6,702,595 to Nelson, et al. issued Mar. 9, 2004 and entitled “Fuse clip for circuit boards” discloses a stable fuse clip for printed circuit boards that has a vertical back plate, a pair of forwardly extending vertical flanges, and a rearwardly extending horizontal flange strengthened against bending. The horizontal flange, the bottom edges of the vertical flanges, and the bottom edge of the back plate are horizontally coplanar and rest on the surface of the circuit board. Two legs extend downwardly through the board from the lateral sides of the back plate, and one leg extends downwardly from the distal end of the horizontal flange.

United States Patent Publication No. 20020115347 to Fukumori, et al. published on Aug. 22, 2002 and entitled “Fuse holder” discloses a fuse holder, which comprises a holder housing having wide walls at the front and the rear and narrow walls on the right and the left and forming a chamber, which will hold the blade terminals of a fuse inserted from the top side and at least a part of the body of the fuse, and two contacts, each of which has an intermediate part fixed to the holder housing, a connecting part, at one end, extending into the chamber to fit with a blade terminal, and a leg, at the other end, extending out of the holder housing to be soldered or press-fitted onto a printed circuit board.

United States Patent Publication No. 20030179070 to Izumi, published Sep. 25, 2003 and entitled “Blade type fuse holder and contact used in the same” discloses a blade fuse holder configured to reduce overall height. The blade fuse holder has a housing that accommodates a pair of contacts. The pair of contacts each has a pair of opposing contact arms that extend from a base part. The pair of opposing contact arms each has a contact projection in a position corresponding to a cut-out formed in the base part so that a distal end of a blade fuse that has been inserted between the pair of opposing contact arms is received in the cut-out.

United States Patent Publication No. 20030228808 to Nelson, et al. published on Dec. 11, 2003 and entitled “Fuse clip for circuit boards” discloses a stable fuse clip for printed circuit boards that has a vertical back plate, a pair of forwardly extending vertical flanges, and a rearwardly extending horizontal flange strengthened against bending. The horizontal flange, the bottom edges of the vertical flanges, and the bottom edge of the back plate are horizontally coplanar and rest on the surface of the circuit board. Two legs extend downwardly through the board from the lateral sides of the back plate, and one leg extends downwardly from the distal end of the horizontal flange.

United States Patent Publication No. 20050215123 to Saller, et al. published on Sep. 29, 2005 and entitled “Fuse holder for blade-type fuses” discloses a fuse holder having an oblong, box-shaped housing comprising plug-in sites for blade-type fuses accessible from one top side of the housing, as well as contact chambers for individual contacts arranged below the plug-in sites in the housing, and a contact channel for a current bridge arranged below the plug-in sites in the housing, wherein the chambers for the individual contacts, based on the axis of the longitudinal extension, are arranged in the housing offset relative to each other and on both sides of the longitudinal axis and wherein the contact channel for the current bridge extends substantially in the zigzag form along the longitudinal axis between the chambers for the individual contacts.

U.S. Pat. No. 6,891,463 to Nagaoka issued on May 10, 2005 and entitled “Mounting structure of fuse connection terminals on board” discloses a plurality of fuse connection terminals (10), each having at one end an insertion portion (11) for the insertion of a fuse terminal, and having at the other end a soldering portion (12) for connection to a circuit board (3), are press-fitted and fixed to a support block (20) at their intermediate portions thereof disposed between the insertion portion (11) and the soldering portion (12). Then, the support block (20) is fixedly secured to the circuit board (3), and the soldering portions (12) of the connection terminals (10) are soldered to the circuit board (3). A crank-shaped bent portion (18) is provided between the press-fitting portion (13) and the soldering portion (12), and projections (14, 15) for transmitting a withdrawal force and an insertion force to the support block (20) are formed respectively at front and rear ends of the press-fitting portion (13).

U.S. Pat. No. 6,551,141 to Liang issued on Apr. 22, 2003 and entitled “Fuse box” discloses a fuse box in which wire distribution blocks each have a receiving chamber and a metal wire clip in the receiving chamber, and tightening up screws are respectively threaded into the wire distribution blocks to compress the respective metal wire clips and to force the respective metal wire clips into positive engagement with respective electric wires. Metal spring plates are mounted in respective oblique insertion holes in the wire distribution blocks to hold fuses in a tilted position, so that less vertical installation space is occupied.

Despite the foregoing, there remains an unsatisfied need for an improved socket configuration. While socket technology and specifically “blade fuse” clip technology exhibits a wide diversity of applications and solutions, all of the aforementioned solutions generally suffer from one or more of the following disabilities, including: (i) being complex and costly to manufacture; (ii) lacking mechanisms to prevent damage due to overstressing of the clip; (iii) a lack of simplified mechanisms to assemble the product in the desired end application; (iv) assuring proper location (positioning) and orientation during insertion; and (v) preventing rotation or movement of the fuse or other device once received within the socket. For example, the prior art automobile fuse clip shown in FIG. 1 addresses one or more of the above shortcomings, however it generally suffers most from not containing any mechanism to prevent overstressing and damage, or rotation, leading to costly rework to replace damaged clips.

### SUMMARY OF THE INVENTION

The invention satisfies the aforementioned needs by providing an improved apparatus and methods for the mounting of electronic components.

In a first aspect of the invention, a clip apparatus having a unitary construction for attaching a structure to a substrate is disclosed. In one embodiment, the apparatus comprises: a closed entry structure receiving element, the component receiving element comprising at least one lead-in feature; at least one terminating element, the terminating element adapted to interface the clip apparatus to the substrate; a spring clip element; and an overstress feature, the overstress feature adapted to prevent the spring clip element from becoming overstressed. The spring clip element is formed from material originally adjacent the at least one terminating element. In one variant, the at least one terminating element comprises two terminating elements, and the spring clip element is formed from material originally disposed between the two leads.

In another embodiment, the apparatus further comprises a support feature, the support feature disposed proximate the structure receiving element and adapted to prevent the structure receiving element from deforming during structure insertion. The support feature comprises two elements deformed to engage respective distal portions of the closed entry receiving element. In another variant, the apparatus further comprises a carrier comprising a plurality of indexing holes and adapted to be detachably connected to at least a portion of the clip apparatus. In another variant, the structure comprises an automotive blade fuse.

In another embodiment, the at least one terminating element comprises at least one surface mounted lead. In another embodiment, the at least one terminating element comprises two substantially parallel through-hole leads. In one variant, the apparatus further comprises a carrier comprising a plurality of indexing holes and adapted to be detachably connected to at least a portion of said clip apparatus. In another variant, the structure comprises an automotive blade fuse.

In another embodiment, the apparatus further comprises comprising a second substantially identical clip apparatus, the two clip apparatus being disposed with respect to another component at a pitch corresponding to that of the pitch of a two-terminal fuse, the disposition of the two clip apparatus permitting substantially simultaneous insertion of the fuse into the two clip apparatus. In one variant, another component is selected from the group consisting of: (i) a printed circuit board; and (ii) a plastic housing.

In another embodiment, the spring clip element comprises a bend, the bend forming a contact point for contacting the structure, the bend also causing a portion of the spring clip element to contact the overstress feature when the structure is inserted into the clip apparatus. In one variant, the contact point is disposed at a location relative to the closed entry element in order to mitigate rotation of the structure within the clip apparatus.

In another embodiment, the spring clip element comprises: a first bend, the first bend forming a first contact point for contacting a first point of the structure; and a second bend, the second bend forming a second contact point for contacting a second point of the structure. The first and second contact points are disposed at different locations along a longitudinal axis of the structure when the structure is received within the clip apparatus.

In a second aspect of the invention, a socket apparatus comprising a unitary metallic structure adapted to receive a terminal of a fuse is disclosed. In one embodiment, the socket apparatus further comprises an overstress feature adapted to prevent damage to a resilient arm of the socket apparatus as a result of the insertion of the fuse clip. The resilient arm and the overstress feature are each formed through deformation of a portion of a substantially planar metallic plate.

In another embodiment, the socket apparatus further comprises a plurality of through-hole terminating leads. In one variant, the socket apparatus further comprises a carrier element.

In another embodiment, the socket apparatus further comprises a closed-entry feature that assures both (i) proper location of the fuse terminal for insertion; and (ii) proper orientation of the fuse terminal. In one variant, the closed entry feature comprises a section of the unitary metallic section having a cavity and a plurality of lead-in features adapted to guide the fuse terminal upon insertion.

In another embodiment, the socket apparatus further comprises surface mount terminating leads.

In yet another embodiment, the resilient arm comprises a bend forming a contact point for contacting the terminal, the bend also causing a portion of the arm to contact overstress feature when the terminal is inserted into the socket apparatus. In one variant, the contact point is disposed at a location selected at least to mitigate rotation of the fuse within the socket apparatus.

In another variant, the plurality of terminating leads comprises two terminating leads, and the resilient arm is formed from material originally disposed between the two leads.

In a fourth aspect of the invention, a method of making a socket apparatus is disclosed. In one embodiment, the method comprises: providing a metallic material comprising a substantially planar configuration; and processing the metallic base material using a stamping process, the act of processing forming the socket apparatus, the socket apparatus comprising: a unitary metallic element adapted to receive a structure, the socket apparatus further comprising an overstress feature adapted to prevent damage to a resilient arm of the socket apparatus as a result of the insertion of the structure. The forming of the socket apparatus comprises deforming the substantially planar metallic material at a plurality of locations on the planar material.

In another embodiment, the method further comprises a plating process occurring after the act of processing. In another embodiment, the method further comprises a plating process occurring before the act of processing.

In another embodiment, the act of deforming comprises forming two terminating elements adapted to terminate the socket apparatus to a printed circuit board. In one variant, the terminating elements comprise through-hole leads.

In a fifth aspect of the invention, a method of making an electrically conductive and unitary socket is disclosed. In one embodiment, the method comprises providing a substantially planar metallic element, stamping portions of the element to form a plurality of separated regions, the separated regions comprising two terminals and a central contact arm disposed substantially between the two terminals, and an entry feature having an aperture formed therein, de forming the contact arm out of the plane of the element into a substantially resilient shape, and deforming the entry feature out of the plane of the element so that at least a portion of the entry feature acts to limit the outward travel of the resilient contact arm during insertion of a component terminal into the socket.

In one variant, the method further comprises stamping portions of the element to form two lateral supports; and deforming the two lateral supports and deforming the two lateral supports out of the plane of the element to engage respective portions of the entry feature so as to support the entry feature during insertion of the component terminal into the socket. In another variant, the act of stamping to form an entry feature comprises stamping to form two guide features proximate the aperture and deforming the two guide features into a shape that aids in properly guiding the component terminal into the aperture during the insertion.

In a sixth aspect of the invention, a method of using a socket apparatus is disclosed. In one embodiment, the method comprises: providing a socket apparatus comprising a unitary metallic structure adapted to receive a terminal of another apparatus in an aperture of the structure, the socket apparatus further comprising a protective feature adapted to prevent damage to a resilient arm of the socket apparatus as a result of the insertion of the terminal; inserting the terminal into the aperture of the structure in an improper manner; deflecting the resilient arm using at least the terminal; and utilizing a protective feature during the deflecting, the protective feature protecting at least the resilient arm.

In one variant, the act of inserting in an improper manner comprises inserting at a substantially oblique angle relative to a plane of the aperture.

In another variant, the act of inserting in an improper manner comprises applying an excessive force normal to a plane of the aperture during the insertion.

In yet another variant, the act of inserting in an improper manner comprises inserting a terminal which is oversized for the structure.

In still a further variant, the act of utilizing a protective feature comprises stopping the deflecting of the resilient arm at a prescribed point of travel to prevent over-stress of the arm.

### BRIEF DESCRIPTION OF THE DRAWINGS

The features, objectives, and advantages of the invention will become more apparent from the detailed description set forth below when taken in conjunction with the drawings, wherein:

FIG. 1 is a front view of a prior art fuse clip contact.

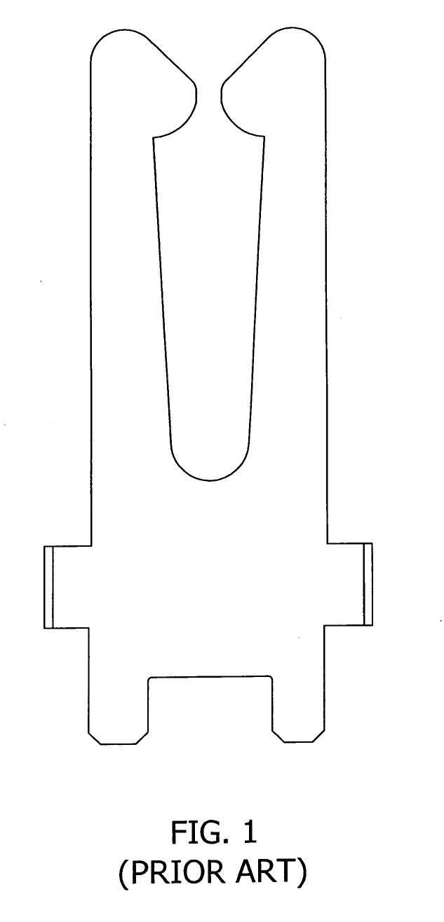

FIG. 2 is a front perspective view of a first exemplary embodiment illustrating two clips mounted on a carrier.

FIG. 2a is a side view of the first exemplary embodiment of the clip as shown in FIG. 2.

FIG. 2b is a front view of the first exemplary embodiment of the clip as shown in FIGS. 2-2a.

FIG. 2c is a front view of the first exemplary embodiment of the clip as shown in FIGS. 2-2b prior to being folded.

FIG. 2d is a side view of another exemplary embodiment of the clip of the invention, wherein a two-point contact system is used for the resilient clip arm.

FIG. 2e is a side view of yet another exemplary embodiment of the clip of the invention, wherein a gap-less construction is used for greater insertion/retraction force.

FIG. 2f is a side view of still another exemplary embodiment of the clip of the invention, wherein a side-mount (e.g., right angle) approach is used.

FIG. 2g is a side view of yet another exemplary embodiment of the clip of the invention, wherein a side-mount approach is used in conjunction with surface mounting, thereby obviating the terminal legs of the clip.

FIG. 3 is a front perspective view of a first exemplary application showing an automotive blade fuse inserted into the first exemplary embodiments of the fuse clips as shown in FIGS. 2-2c.

FIG. 3a is a front perspective view of the fuse clips of FIG. 3 mounted within a PCB.

FIG. 3b is a front perspective view of the fuse clips of FIG. 3a enclosed within a plastic support housing.

FIG. 4 is a front perspective view of a second exemplary embodiment illustrating two clips mounted on a printed circuit board.

FIG. 4a is a side view of the second exemplary embodiment of the clip as shown in FIG. 4.

FIG. 5 is a front perspective view of a third exemplary embodiment illustrating two clips adapted for flush mounting on a printed circuit board.

FIG. 5a is a side view of the third exemplary embodiment of the clip as shown in FIG. 5.

FIG. 6 is an exemplary method for making and using the clip of the present invention.

### DETAILED DESCRIPTION OF THE PREFERRED EMBODIMENT

Reference is now made to the drawings wherein like numerals refer to like parts throughout.

As used herein, the terms “electrical component” and “electronic component” are used interchangeably and refer to components adapted to provide some electrical function, including without limitation, fuses, transformers, filters, inductors, capacitors, resistors, operational amplifiers, transistors and diodes, whether discrete components or integrated circuits, whether alone or in combination. In addition, other electronic devices such as for example, so-called EMI shields and the like, which could be considered passive in nature, are considered encompassed as possibilities within the meaning of this term.

As used herein, the term “progressive stamping” shall be understood to include any metalworking method including, without limitation, punching, coining, bending or any other method of modifying or otherwise changing a metallic material, combined with an automatic feeding system.

As used herein, the terms “clip” and “socket” are used generally interchangeably to refer to a structure capable of receiving or holding another structure or component.

It will be appreciated that while described primarily in the context of fuses, the exemplary embodiments described herein, and the broader invention itself, are in no way limited to fuses, but rather may be applied to literally any electrical or electronic application requiring this type of functionality (i.e., insertable/removable electrical connectivity).

### Overview

In one salient aspect of the invention, an improved socket or clip adapted to provide an interconnect between an electronic component, such as an automotive blade fuse, and a printed circuit board or other device, is disclosed. The clip comprises a substantially unitary structure for attaching the electronic component to a parent device; e.g., printed circuit board substrate. The use of such unitary structure affords significant economies in terms of manufacturing (i.e., ease of manufacturing, and reduced cost); in one variant, the clip is formed from a single planar piece of metal, thereby allowing for rapid and cost-effective processing.

The exemplary embodiment of the invention also advantageously provides a “closed entry” function; i.e., it forces a user or machine to insert the fuse or other component into the clip in the correct location. Such closed entry feature may also be polarized, thereby forcing the user or machine to insert the terminal in the correct orientation as well.

In one embodiment, the clip also comprises a high-strength overstress feature for preventing the spring clip element (including its resilient contact arm) from becoming overstressed during insertion of a terminal due to e.g., improper insertion angle, the application of excessive force, and/or use of terminal which is improperly sized.

### Component Clips—Through-Hole Configurations

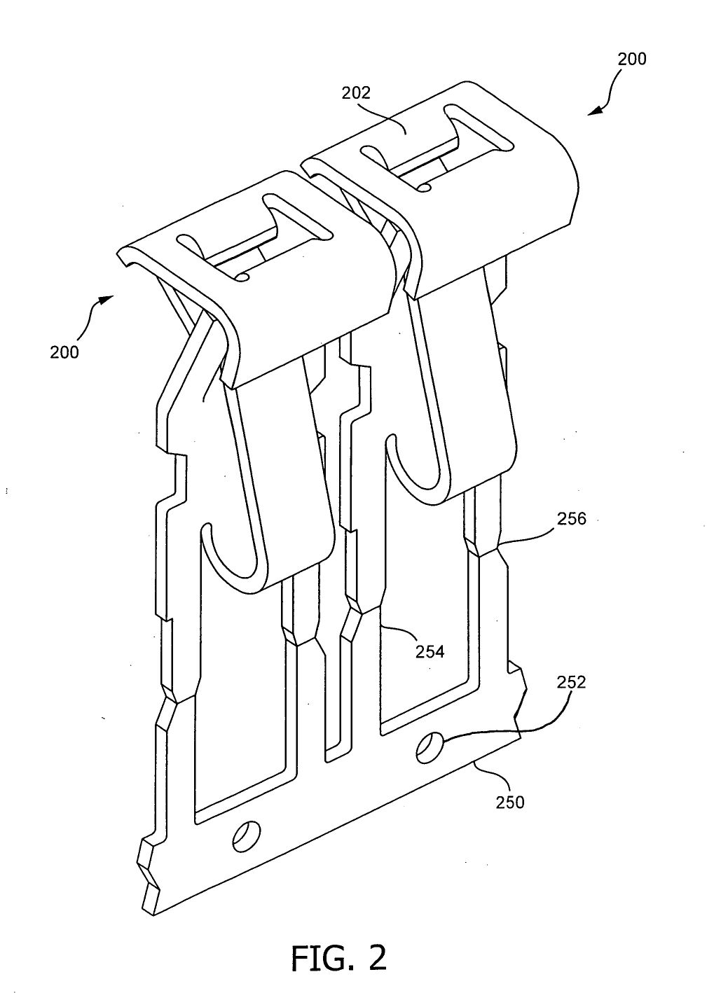

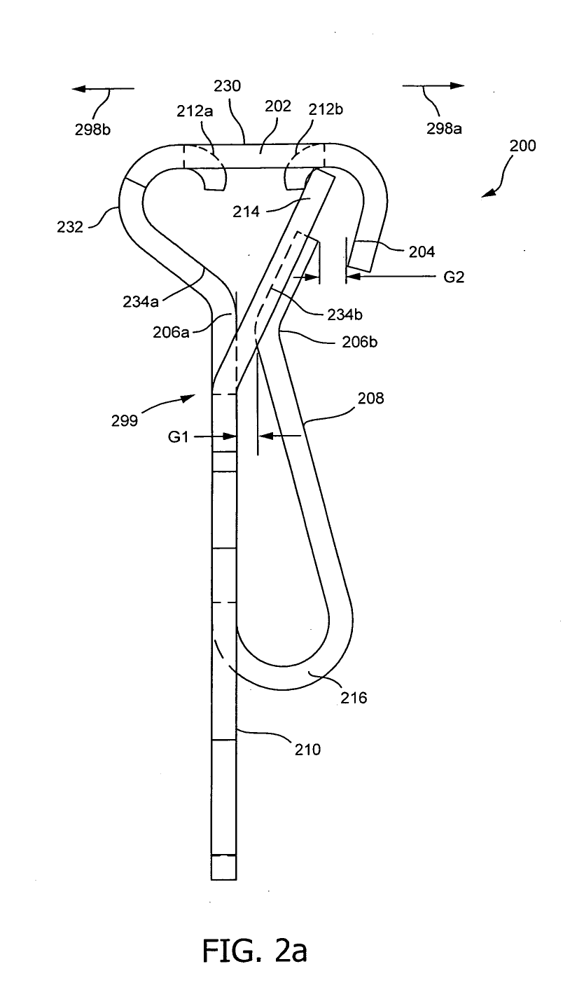

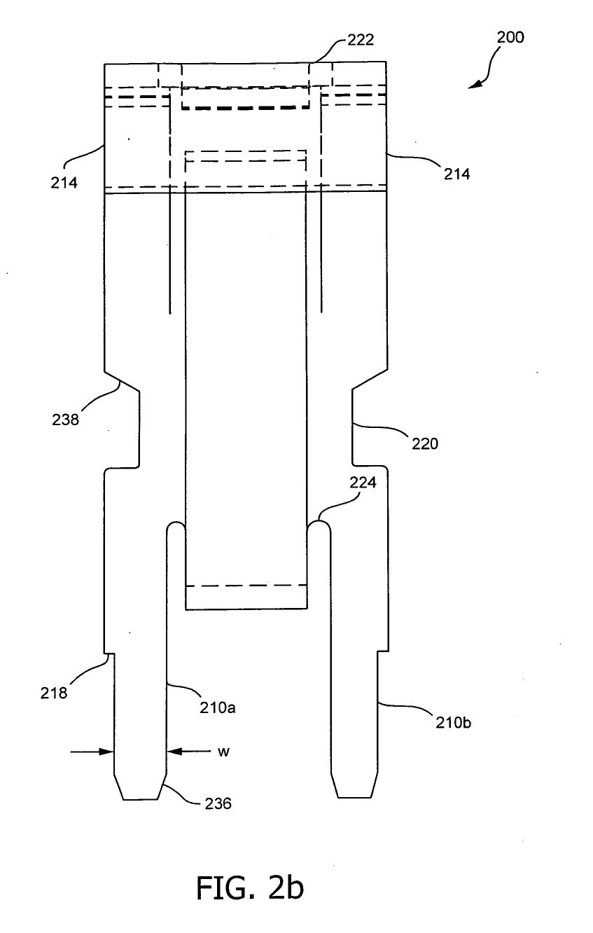

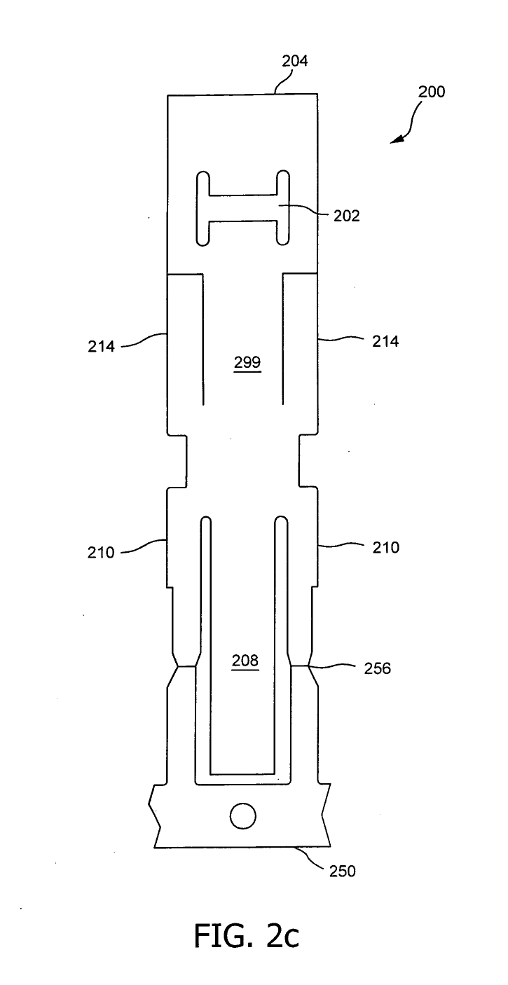

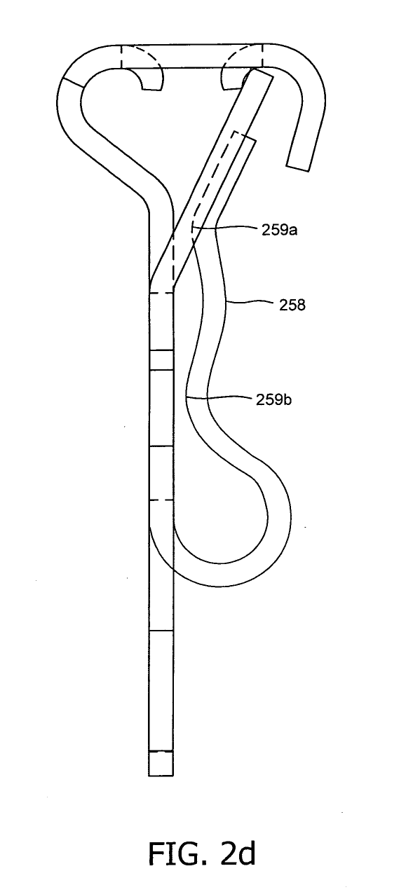

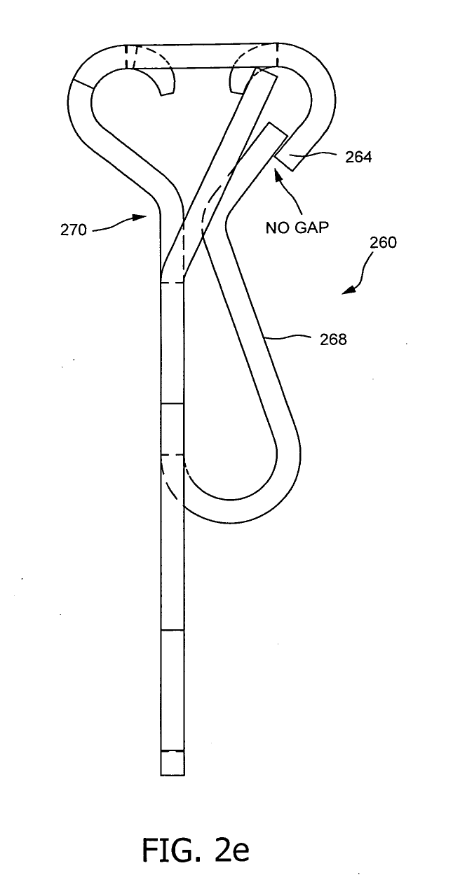

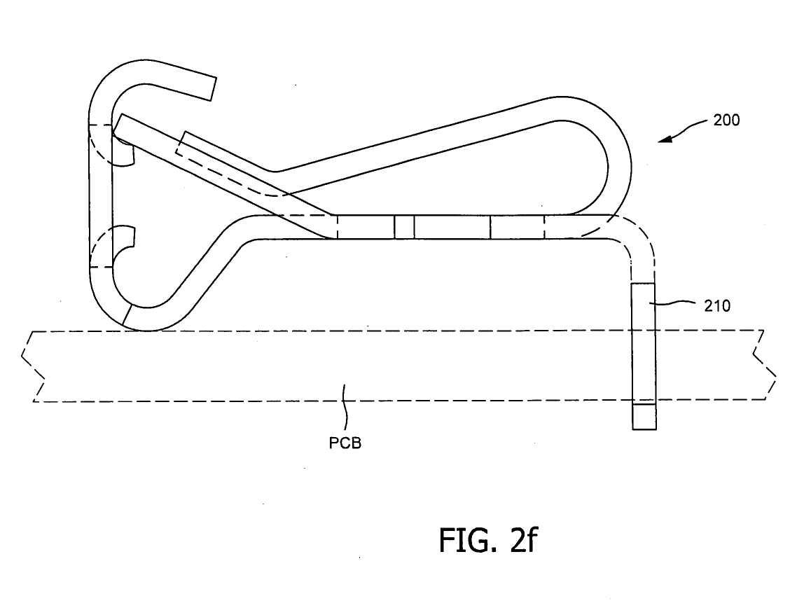

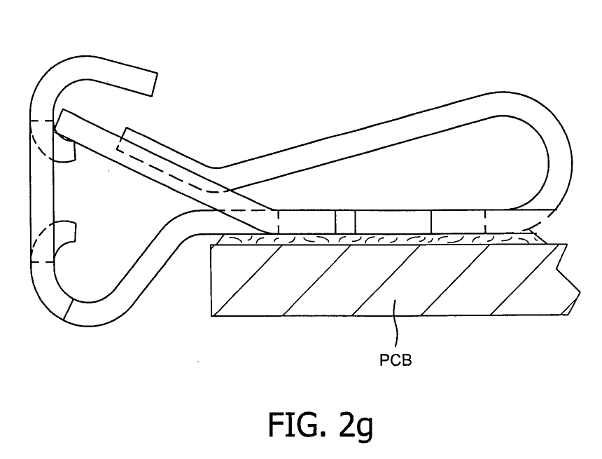

Referring now to FIG. 2, a first exemplary embodiment of a clip 200 is shown attached to a feeder carrier 250. As shown in FIG. 2, the clips 200 are arranged on a feeder carrier 250 to facilitate manufacturing and handling of the clips 200. For example, during the manufacture of the clips 200, the carrier holes 252 can be utilized to feed the raw material of the clips through, e.g. progressive stamping equipment. After manufacture, the clips 200, still attached to the carrier 250 can be reeled onto a standard diameter spool for shipment and optional automated handling. The clips 200 are attached to the carrier 250 via carrier legs 254 comprising score lines 256 that facilitate the removal of the clips 200 from the carrier during processing and handling. Carrier holes 252 are preferably spaced at a uniform interval spacing (i.e. “pitch”) with the pitch preferably defining the clip-to-clip spacing.

Referring now to FIG. 2a, a side view showing a first exemplary clip 200 is described in detail. The clip 200 comprises a phosphor bronze base material plated with a tin-lead (SnPb) over-plate over a nickel under-plate, the nickel facilitating the plating of the tin-lead. Other base materials and plating (such as for example, exemplary RoHS compliant materials) could readily be used with the advantages and drawbacks being well understood by a skilled artisan and hence, these alternative choices will not be discussed further herein.

The top surface 230 of the clip 200 comprises a cavity 202 partially defined by lead-in features 212a, 212b. The cavity 202 is specifically adapted to receive a pre-defined lead from an electronic component, such as e.g. an automotive blade fuse lead, although myriad other components of the so-called “through hole” variety could be readily substituted in place of the aforementioned blade fuse. The lead-in features 212 generally curve or bend downwardly (i.e. away from the inserted lead) to help facilitate the alignment and reception of the aforementioned lead. While generally considered as advantageous for alignment and reception purposes, the lead-in features could also serve as an electrical contact if desired. In the present embodiment, the centerline of the cavity 202 will lie coincident with the centerline of the opposing contact features 206a, 206b although this is by no means a requirement in all cases. Also, in the current embodiment, the top surface 230 of the clip 200 will generally lie perpendicular to the legs 210 of the clip 200, although any other angle could readily be designed based on a desired application given the present disclosure.

It will be appreciated that the exemplary embodiment of the invention advantageously provides a “closed entry” functionality; i.e., forces a user or machine to insert the fuse or other component into the clip in the correct location. The exemplary clip is also optionally polarized, such that the correct orientation of the component being inserted (as well as placement thereof as previously described) is dictated by the clip structure. Hence, the exemplary clip allows insertion of the component in only the correct location and orientation.

The top surface 230 is supported on its one side by its integral bend 232 leading to the through-hole mounting leg 210, and simultaneously supported on the opposite side by one or more support legs 214. These supporting features 232, 214 prevent the top surface from being bent out of a desired position relative to the legs 210. For example, when an electronic component is inserted into the cavity 202 improperly, the inserted component could potentially bend and damage the top surface 230 if it were not properly supported. These features are particularly important where the cavity 202 is obscured to a user by other components in close proximity to the clip 200 or when a large electronic component makes ease of insertion into the clip 200 difficult. While support legs 214 are not shown as securely attached to the top surface 230, it is envisioned in certain applications that this added mechanical stability may be desired. For example the support leg 214 could be fed through an aperture located on the top surface and swaged or soldered to the top surface 230, or could alternatively be soldered directly to the bottom side of the top surface 230.

Extending downwardly from the top surface 230 is an overstress feature 204 which prevents, inter alia, the over flexing (via plastic deformation) of clip arm 208. In one embodiment, gap G2 defines the largest amount of deflection allowed for spring clip arm 208. As a terminal or pin is inserted into the cavity defined by gap dimension G1 and into the opposing contact points 206 of spring clip arm 208, the overstress feature 204 will prevent an oversized component from damaging the clip 200. Alternatively, if a user inserted an electronic component into the clip 200 at an improper angle, the clip spring arm 208 might become overstressed and damage the overall clip 200.

The overstress feature 204 could also optionally extend laterally from the support arms 214, thereby obviating the feature being located off of the top surface 230. Myriad other shapes and configurations could be used, although the embodiment of FIG. 2a is considered exemplary for reasons that will be discussed below with regards to FIG. 2c.

The illustrated overstress feature is also advantageously configured to have significant strength as compared to other approaches; i.e., the use of the clip arm 208 and the interior surface of the closed entry feature near the top of the clip 200 allows for significant downward force to be exerted on the fuse or other component inserted into the clip without damaging the clip. The resilient clip arm 208 is also independent of the closed entry feature(s), which provides several advantages.

In another exemplary embodiment, the clip is configured to provide multiple points of contact for the fuse terminal or other component inserted into the clip. This allows for a more positive electrical connection, as well as greater current carrying capability (due to the increased contact surface area through which current can flow). The multiple points may comprise for example: (i) the top portion of the clip; and (ii) one or more locations along the clip resilient member.

It is further noted that the overstress feature 204 in conjunction with the clip arm 208 (when the two components contact one another upon terminal insertion) can also act as an additional current-carrying and heat dissipation path, thereby allowing for greater current capacity.

While primarily discussed with regards to damage prevention, the overstress feature 204 may not necessarily be used to prevent damage to the clip 200, but rather could be used as a means to screen out or identify improperly inserted electronic components for other reasons such as consumer safety. For example, suppose the clip 200 is designed specifically for a hypothetical electronic component rated for a particular amperage level (i.e. 20 amps). Further suppose that amperage rating was directly correlated to and identified by the thickness of the inserted lead. In this Example, the 10 amp components would have a thickness of 0.5 mm, while 20 amp components would have a lead thickness of 0.8 mm. In this example, the clip 200 is designed so that when gap G1 is deflected to approximately 0.6 mm, gap G2 will close, preventing the clip arm 208 from opening further. If a user attempts to insert a 20 amp component into a 10 amp rated clip, the retention feature will frustrate the insertion of the improper component into the clip 200. Myriad other configurations for e.g., addressing safety concerns are also possible given the present disclosure.

After the initial insertion of a lead into cavity 202, the lead will then be received by the contacting portions 206 of the clip 200. The contact leads comprise lead in features 234a, 234b to help align and direct the inserted pin into contacting portions 206a, 206b, leg feature 210 and clip arm 208. Clip arm 208 is integrally connected to the body of the clip, via radial bend 216. In the illustrated embodiment, the clip arm 208 is designed to a predetermined length. This predetermined length, in cooperation with the radial bend 216, and material composition and thickness will define a desired insertion force (e.g. 0.41 bf/0.001″ deflection). By varying the aforementioned parameters, different spring constants (“k”) can be achieved to establish a desired amount of insertion force. For example, in one embodiment a higher spring constant “k” may be desired, however the clip arm length could not be lengthened because of other design constraints. A designer could then choose a material having a higher modulus of elasticity or alternatively, or in combination, could choose a thicker base material thickness, make the spring member wider, etc. If a lower “k” is desired, the opposite design strategy may be employed.

Referring now to FIG. 2b, various features of the legs 210 are now more readily visible. In the present embodiment, the clip 200 comprises two (2) legs 210, although the present design could be readily adapted to incorporate more or less legs, the quantity two merely being exemplary. Each of the legs 210 comprises lead in features 236 which facilitate the insertion of the legs into holes that are drilled in a printed circuit board. In one embodiment, the holes (not shown) will be plated through holes adapted for wave soldering operations that are common in the electronic components industry. In another embodiment, the holes may be sized for an interference fit with the legs 210 so that a mechanical connection is employed as well as an electrical connection. While the width “w” generally allows for the legs 210 to be freely inserted into the printed circuit board holes, other variations are contemplated. In other embodiments, the electrical joint may be obviated altogether (in lieu of a mechanical joint) in purely mechanical systems.

In addition to the aforementioned features, the legs 210 also comprise standoffs or stop members 218 adapted to prevent over insertion of the clip 200 into the printed circuit board (not shown). The standoff 218 provides a precision depth for the legs 210 to be inserted to ensure that the top surface 230 is at the proper height above the printed circuit board, and that the bottom portion of the legs 210 do not extend too far past the bottom surface of the printed circuit board where they could interfere with other components in close proximity to the clips 200.

At the point where the legs 210 meet the body 220, radial features 224 help strengthen the body-leg joint to prevent breakage during clip insertion. As is well understood in the mechanical arts, radial features at joint intersections help distribute stresses over a larger area within the joint to improve the robustness of the overall design. This is particularly important where there is substantial likelihood that interference will be encountered during clip 200 insertion, or alternatively, where stress might be encountered during other steps in the manufacture and handling processes, such as e.g. when the clip 200 is removed from the carrier 250.

Other features such as locking features 238 can be incorporated for the purpose of mechanical interconnection with other components during the final assembly if desired. For example, in an automotive application, the clips 200 may be utilized in an automotive fuse block. Automobiles typically have a fuse terminal block which is mounted adjacent the instrument panel or forward fire wall to provide a means for securing fuses and for providing connections to various electrical components of an automobile such as headlights, horns, power seats, power windows and numerous other electrical options which can be customer selected on automobiles. The legs 210 will be inserted into plated through-hole connections on a printed circuit board and subsequently soldered, while features 238 will interconnect with respective features on an outer mechanical housing. The outer mechanical housing may contain information with regards to amperage ratings of the designated equipment described above that a particular fuse is adapted to protect, or it could simply contain identifiers (e.g. numerical identifiers) that would cross-reference with an automotive manual so that a particular fuse, its desired rating, and designated equipment are all clearly identified and available to a user.

Referring now to FIG. 2c, a primary advantage of the aforementioned clip design is more readily apparent. FIG. 2c shows a flattened version of the clip 200 shown prior to being formed into the shape shown in, inter alia, FIG. 2. As can be seen in FIG. 2c, the design of the current embodiment has distinct advantages in terms of cost over other prior art designs, as it comprises a (i) unitary, single piece construction, requiring little or no assembly work by an individual assembler; (ii) does not require additional insert molding of plastic around the clip (although an insert-molded plastic housing could be incorporated if desired); and (iii) wastes very little material during the stamping process so that raw material costs are minimized.

In contrast to other designs (e.g., those having two resilient arms, the illustrated embodiment requires only one resilient arm, and this is deformed from flat stock as shown best in FIGS. 2b-2c. Specifically, the illustrated embodiment of FIGS. 2a-2c has the sole resilient arm formed from material between the mounting legs. This approach requires both less material, and also less processing steps than would otherwise be required for a two-arm design.

It is also noted that the illustrated embodiment of FIG. 2a includes a “tripod” feature (best shown in the triangular shape formed at the top of the clip 200 of FIG. 2a), which prevents crushing of the closed entry feature; i.e., the triangular shape maintains the top surface 230 of the clip 200 substantially horizontal to the vertical leg(s) 210, even under significant downward pressure or insertion force placed on the closed entry feature (such as during insertion of the fuse or other component within the cavity 202). This triangular feature is formed using the aforementioned one piece construction as well, thereby obviating a second component to provide this function (or relying on the housing or another external component to provide support or protection for the closed entry feature).

It is also noted that the exemplary configuration of FIG. 2a provides another benefit from the perspective of constraining motion of the inserted fuse terminal or other component. Specifically, as shown best in FIGS. 2a and 2c, the central region 299 of the clip 200 is substantially planar (flat), which allows for a close conformance of this region to the inserted terminal or other component. Hence, any front-to-back forces placed on the fuse or other inserted component (such as by pushing the non-inserted portion of the fuse/component in a direction 298a normal to and away from the plane of the central portion 299 of the clip 200) are mitigated, the central portion 299 and the resilient arm 208 cooperating to maintain the orientation of the fuse/component terminal substantially upright within the clip 200.

Moreover, the resilient clip arm 208 and the central portion 299 cooperate to restrain movement of the fuse/component terminal in the opposite direction (i.e., in a direction 298b normal to and toward the plane of the central portion 299 of the clip 200). Specifically, the contact point of the resilient arm 208 and the inserted terminal is located below the top surface 230 and low enough so as to provide a retarding force or torque around the pivot point 212a of the inserted terminal. Stated differently, were the contact point of the resilient arm 208 to the terminal higher up or closer to the top surface 230, the inserted fuse or other component would be significantly easier to rotate in the indicated direction 298b.

FIG. 2d shows another alternate embodiment of the clip 200, wherein a two-point contact system is used for the clip arm 258. Specifically, a first contact point 259a and a second point 259b are used, thereby providing additional stability and rigidity when the fuse/component terminal is inserted into the clip.

The illustrated embodiments of the clip may also be configured with a “push shoulder” (not shown) on the body or near the top of the clip, which allows for ready application and translation of downward force (such as via a user or a press-fit insertion machine) to ensure complete insertion of the legs 210 into their corresponding apertures in the host device (e.g., PCB).

In another alternative embodiment of the clip, a “no gap” clip configuration may be used, such as that shown in FIG. 2e herein. In this embodiment, the gap G2 between the resilient clip arm 208 and the overstress feature 204 of the embodiment of FIG. 2a herein is eliminated, such that the clip arm 268 is initially engaged against the overstress feature 264, thereby requiring a greater insertion and retraction force (due to, inter alia, the required deflection of the clip arm 268 and the top portion 270 of the clip 260 in order to permit insertion and removal). This embodiment is especially useful where there is less concern about over stressing (for instance, when a housing or other external component provides proper anti-overstress capabilities).

In still another embodiment, a side-mount approach is used (see FIG. 2f). Specifically, the terminal legs 210 of the clip 200 are disposed at a 90-degree angle (or in another desired angular relationship) with respect to the remainder of the clip, thereby allowing for insertion of the fuse terminal or other component into the clip in a direction different than that of the legs 210. The clip 200 may also be supported or mounted to the parent device (e.g., PCB) to which it is attached, such as via an encapsulant, adhesive, or supported by an external housing or other means, in order to make the assembly more rigid.

In another variant of that shown in FIG. 2f, the through-hole terminals (legs 210) are obviated in favor of a surface mount approach, wherein the clip body is mounted resilient arm-side up, with the contact portion of the clip 200 bonded (e.g., soldered) to the appropriate electrical contact pad on the PCB or other parent device. See FIG. 2g.

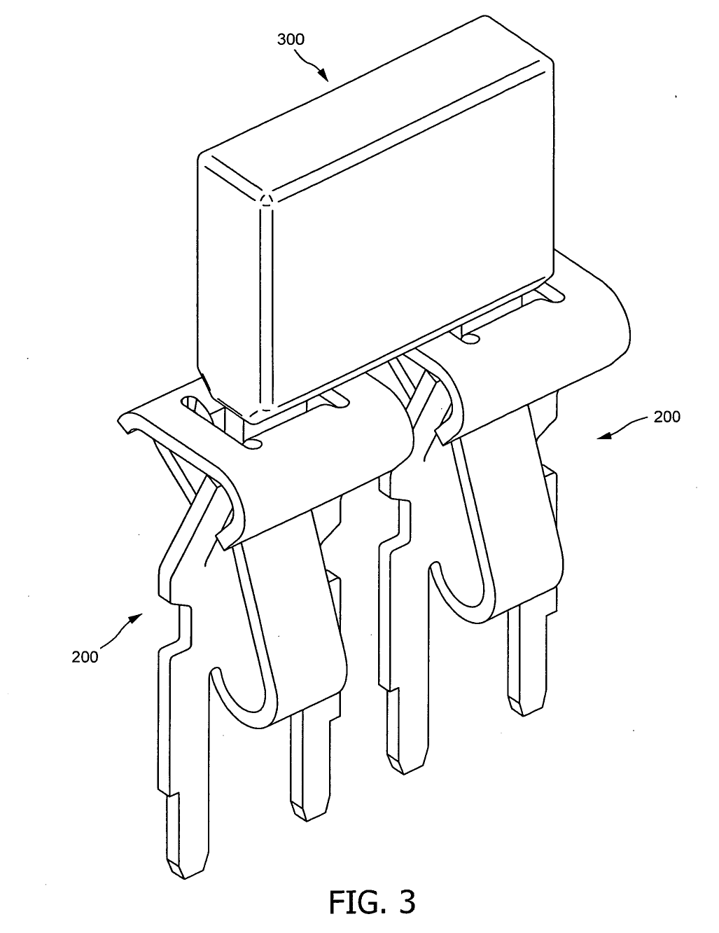

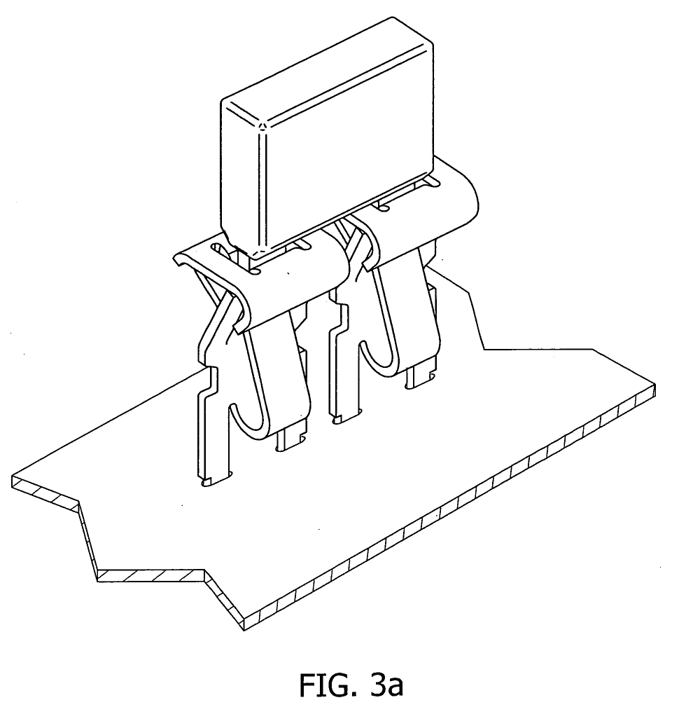

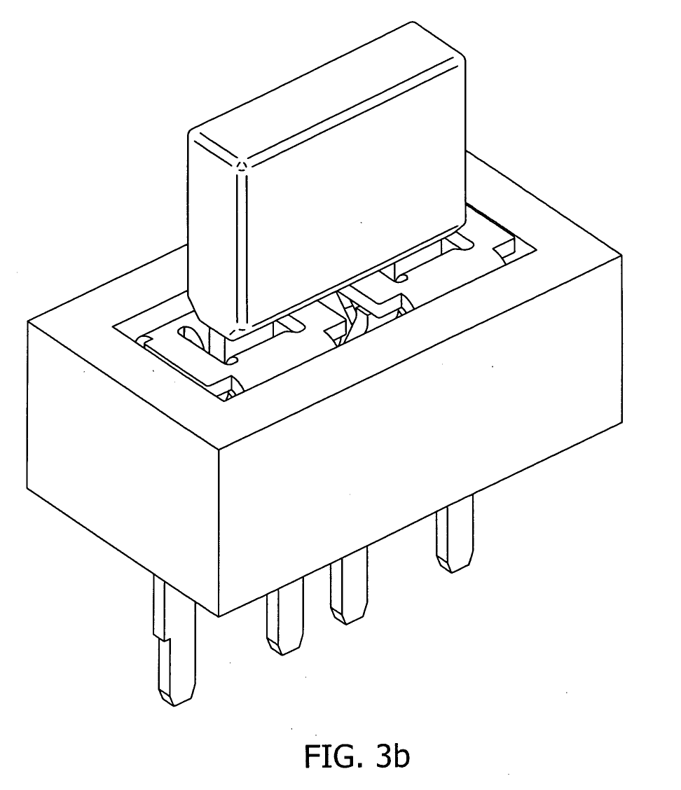

FIG. 3 shows one exemplary application for the clip 200 described with regards to FIGS. 2-2b (as well as that of FIGS. 2d-2g). In this embodiment, two clips 200 are soldered to a printed circuit board (not shown) at a pre-specified distance and adapted to receive an automotive blade fuse.

It will further be recognized that the clip 200 can be made “on-pitch” (i.e., with comparable pitch) to that of the fuse blades, thereby allowing two insertions simultaneously. See, e.g., FIG. 3a, which illustrates the fuse clips of FIG. 3 mounted within a PCB and receiving a fuse therein. FIG. 3b illustrates the fuse clips of FIG. 3a enclosed within an optional plastic support housing.

### Component Clips—Surface Mount Configurations

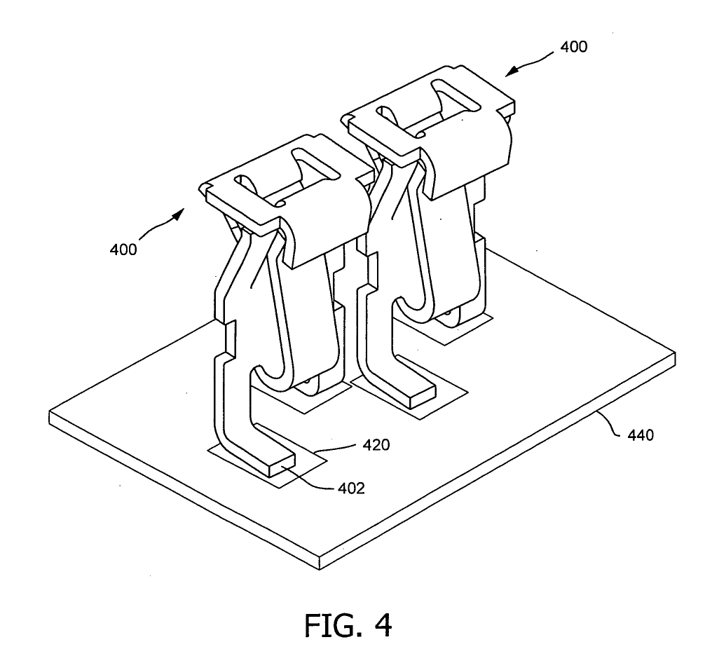

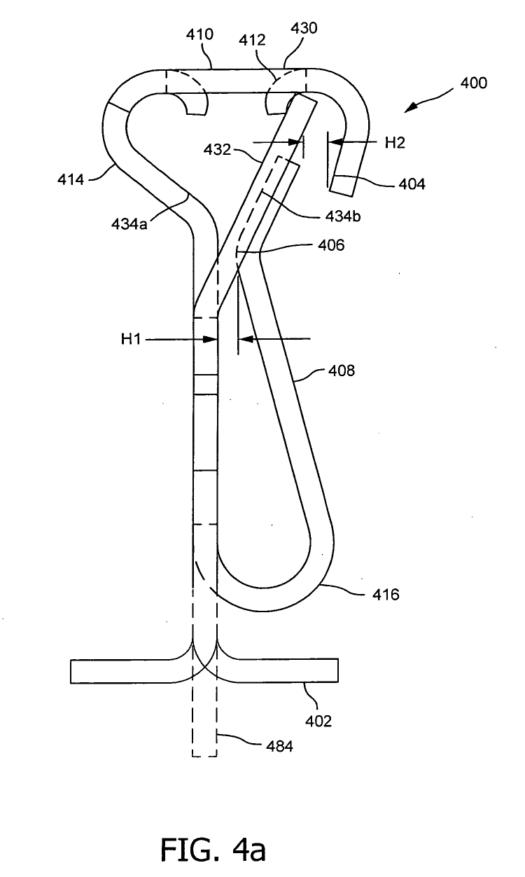

Referring now to FIG. 4, a second exemplary embodiment of a clip 400 is shown adapted for surface mounting to a printed circuit board. In the embodiment shown, and for purposes of stability, the clips 400 comprise at least two sets of legs 402 which extend in parallel, albeit opposite directions. While FIG. 4 shows two (2) legs extending in opposite directions, other configurations are possible. For example, in one alternate embodiment, each leg 402 shown in FIG. 4 could be sub-divided into two separate and distinct legs, with each separated leg extending in opposite directions. In another embodiment, and as best shown in FIG. 4a, it is also possible that one lead 484 could be adapted to provide a mechanical through-hole connection, while one or more leads 402 would be mounted in a conventional surface mounted orientation. Myriad other design alternatives would be readily apparent given the present disclosure, such as e.g., compliant tail approaches (relying generally on a so-called “eye of the needle” configuration which provides friction).

Referring again to FIG. 4a, the clip 400 generally comprises a stamped and folded conductive base material plated with solderable plating material deposited over the base material. However, a common design constraint in the electronics industry is cost and phosphor bronze with a tin-lead overplate tend to be one of the more cost-effective material solutions in many industrial markets around the world.

The top surface 430 of the clip 400 comprises a cavity 410 defined by lead in features 412. The cavity 410 is similar to the embodiments of FIGS. 2-2c, as it is specifically adapted to receive a pre-defined and appropriately sized lead from an electronic component, such as so-called “through hole” electronic components. The lead-in features 412 generally curve or bend downwardly to help facilitate the alignment and reception of the aforementioned lead. In the present embodiment, the center line of the cavity 410 will lie coincident with a vertically extending centerline of the opposing contact features 406 although this insertion centerline could literally be adjusted at a wide variety of angles to be readily adapted to a wide variety of design requirements. In the present embodiment, the top surface 430 of the clip 400 also generally will lie parallel (i.e. in a typical range of 0-8 degrees) with respect to the orientation of legs 402 of the clip 400.

Similar to the embodiments disclosed with regards to FIGS. 2-2c, the top surface 430 is supported on one side by its integral bend 432 leading downwardly to leg 402, and simultaneously supported on the opposite side by support legs 414. These support features 432, 414 prevent the top surface 432 from being bent out of a desired position relative to the legs 402 when an electronic component is inserted into the cavity 410. As previously discussed, this is particularly important where the cavity 410 is obscured to a user by other components in close proximity to the clip 400 or when a large electronic component makes ease of insertion into the clip 400 difficult.

Extending downwardly from the top surface 430 is an overstress feature 404 which prevents the over flexing of clip arm 408. In one embodiment, gap H2 defines the largest amount of deflection allowed for clip arm 408. As a terminal or pin is inserted into cavity 410 and into the contact points 406 defined by gap dimension H1, overstress feature 404 will prevent an oversized component from damaging the clip 400. In alternate embodiments, the overstress feature 404 may not necessarily be necessary to prevent damage to the clip 400, but rather could be used as a means to screen out improperly inserted electronic components for other reasons such as safety as discussed with regards to FIG. 2a previously.

After the initial insertion of a lead into cavity 410, the lead will then be received by the contacting portions 406 of the clip 400. The contact portions comprise lead in features 434a, 434b to help align the inserted pin into contacting portions 406 and spring clip arm 408. Clip arm 408 is integrally connected to the body of the clip, via radial bend 416. In the illustrated embodiment, the clip arm 408 is designed to a predetermined length. This predetermined length, in cooperation with the radial bend 416, and material composition and thickness will define a desired insertion force (e.g. 0.41 bf/0.001″ deflection). By varying the aforementioned parameters, different spring constants (“k”) can be achieved to establish a desired amount of insertion force.

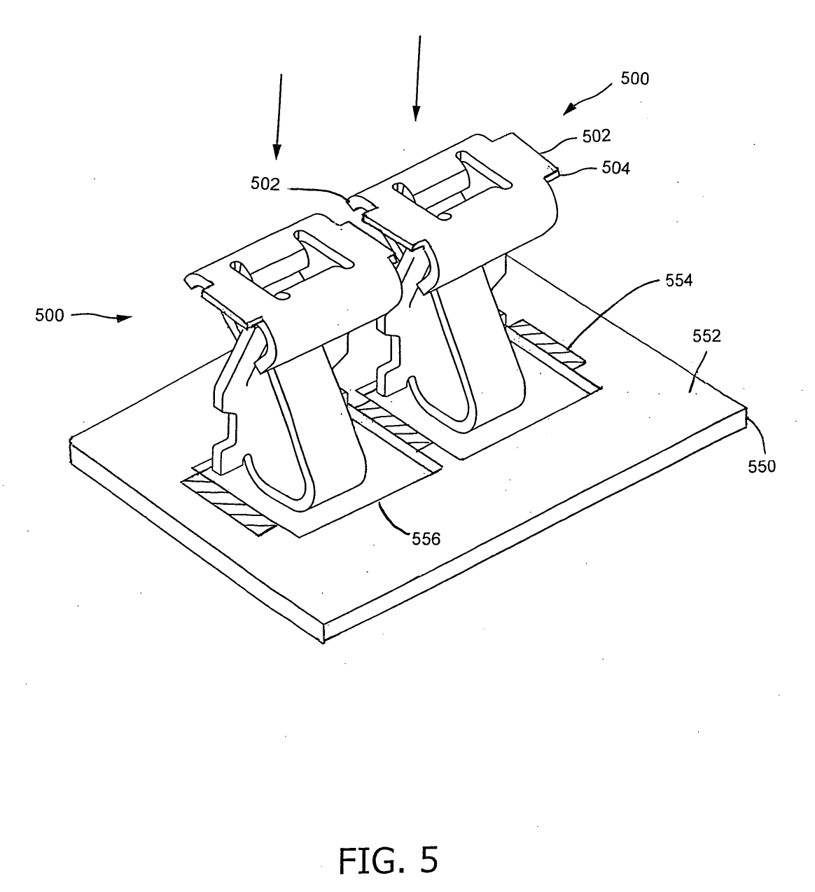

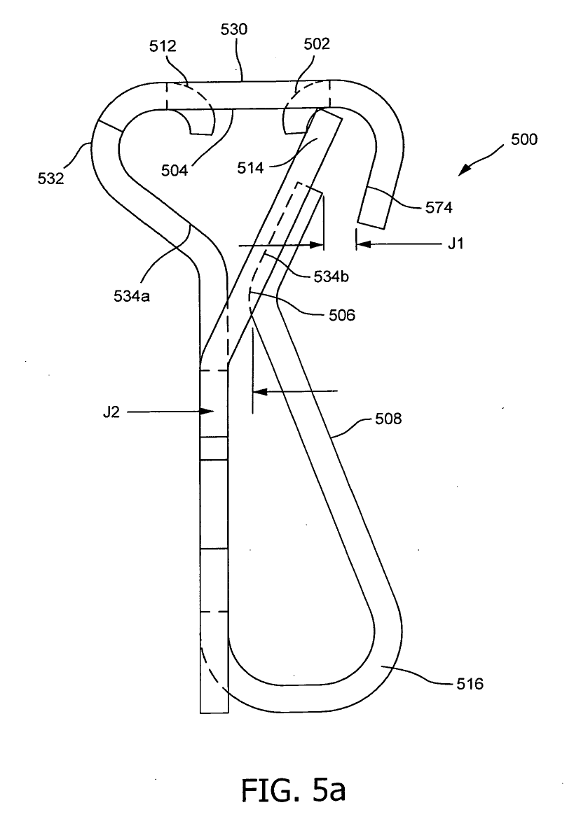

Referring now to FIG. 5, a third embodiment of a clip 500 adapted for surface mounting to a printed circuit board 550 is described in detail. In this embodiment, the surface mounting leads are obviated in favor of flush mounted surface mounting tabs 502. By placing the mounting tabs 502 at the top of the clip 500, the vast majority of the clip will be positioned underneath the printed circuit with only the thickness of the clip 500 positioned above the printed circuit board 550.

Functionality of the mounting tabs 502 is perhaps best described by the manufacturing process with which they are intended to be used. Prior to the placement of the clips 500 onto the printed circuit board 550, a solder paste will be screen printed onto the printed circuit board pads 554 that are positioned on the top surface 552 of the printed circuit board 550. Each clip 500 is lowered into its respective mounting hole 556, until the bottom surface 504 of the mounting pad 502 rests flush with the solder paste resident on pads 554. After heating up the solder paste to its “reflow” temperature (via IR reflow and the like), the clips 500 will be electrically and mechanically secured to the printed circuit board 550.

Referring to FIG. 5a, depicting a side view of the exemplary clip 500 described with regards to FIG. 5 above is discussed in detail. The clip 500 generally comprises similar features as described with reference to FIGS. 2a and 4a above. The clip 500 generally comprises a stamped and folded base material with a phosphor bronze base material plated and a tin-lead (SnPb) over-plate being exemplary.

The top surface 530 of the clip 500 comprises a cavity defined by lead in features 512. The cavity is adapted to receive a pre-defined appropriately sized lead from an electronic component, such as e.g. an automotive blade fuse lead, capacitor, etc., although myriad other components of the so-called “through hole” variety could be readily substituted in place of the aforementioned blade fuse. The lead-in features 512 generally curve or bend downwardly to help facilitate the alignment and reception of the aforementioned lead. In the present embodiment, the center line of the cavity will lie coincident with the centerline of the contact features 506. The top surface 530 of the clip 500 also generally will lie parallel to the mounting tabs 502.

The top surface 530 is supported on one side by its integral bend 532 while simultaneously supported on the opposite side by support legs 514. These support features 532, 514 add rigidity and prevent the top surface from being bent out of a desired position relative to the clip portion 508 when an electronic component is inserted into the cavity. This is particularly important where the cavity is obscured to a user by other components in close proximity to the clip 500 or when a large electronic component makes ease of insertion into the clip 500 difficult.

Extending downwardly from the top surface 530 is an overstress feature 574 which prevents, inter alia, the over flexing of clip arm 508. In one embodiment, gap J1 defines the largest amount of deflection allowed for clip arm 508. As a terminal or pin is inserted into cavity and into the contact points 506 defined by gap dimension J2, overstress feature 574 will prevent an oversized component from damaging the clip 500. In alternate embodiments, the overstress feature 574 may not necessary to prevent damage to the clip 200, but rather could be used as a means to screen out improperly inserted electronic components for other reasons such as safety.

After the initial insertion of a lead into cavity, the lead will then be received by the contacting portions 506 of the clip 500. The contact leads comprise lead in features 534a, 534b to help align the inserted pin, contacting portions 506, and clip arm 508. Clip arm 508 is integrally connected to the body of the clip, via radial bend 516. In the illustrated embodiment, the clip arm 508 is designed to a predetermined length. This predetermined length, in cooperation with the radial bend 516, and material composition and thickness will define a desired insertion force. By varying the aforementioned parameters, different spring constants (“k”) can be achieved to establish a desired amount of insertion force. For example, in one embodiment a higher spring constant “k” may be desired, however the clip arm length, in this example, can not be lengthened. A designer could then choose a material having a higher modulus of elasticity or alternatively or in combination could choose a thicker base material thickness, etc. If a lower “k” is desired, the opposite design strategy may be employed.

### Methods

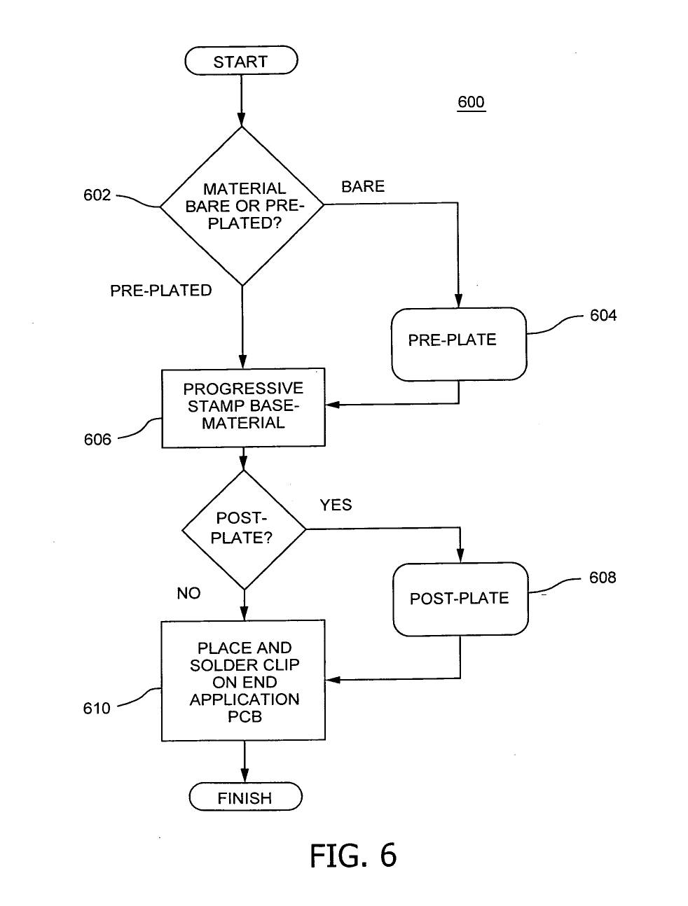

Referring now to FIG. 6, an exemplary method 600 for making and using the clip of the present invention is described in detail. In step 602, a reeled spool of base material is unreeled, either for the purpose of becoming pre-plated prior to stamping in step 604 or stamped via processing equipment such as progressive stamping equipment in step 606. The base material will ideally be a copper based alloy such as phosphor bronze which is exemplary because it is readily available, low-cost, and perhaps most importantly, it is conductive and solderable when plated. If a copper based alloy is chosen, it will most likely need to be plated at steps 604 or alternatively at step 608. If the material chosen is a material such as Nickel Silver, steps 604 and 608 may be obviated in favor of the properties of the underlying base material.

In step 604, an optional pre-plating step is next performed. The processing of base metals such as copper based alloys is well understood and as such will not be discussed further herein, but rather the advantages and disadvantages of pre-plating versus post-plating is described. Pre-plating is advantageous as it can generally be more efficiently processed because the base material is reeled. The disadvantages, however, are that exposed edges of the base material will be prevalent after stamping and forming operations in step 606. In some applications, this may cause solderability or cosmetic concerns for the end product clip.

In step 606, the base material (whether pre-plated or not) is fed through a series of progressive stamping dies which form the base material into the desired shape, such as that shown in FIG. 2, previously described herein.

In step 608, the base material which has now been stamped and formed is post-plated. Post-plating in step 608 has the advantage of plating exposed edges that were formed during processing step 606. Post-plating processes are generally more costly than pre-plating processes that can be used in pre-plating step 604. However, if the design to be post-plated is such as that disclosed in FIG. 2 (i.e. the clips 200 reside on a carrier 250), then the post-plating process can occur in a similar manner as step 604 and therefore can be processed much more efficiently. However, this does mean that there will be exposed base material after separation from the carrier at score line 256, but this amount of exposure is considered minimal and will likely not produce any serious solderability or cosmetic concerns.

In step 610, the clip is placed and soldered to an end product printed circuit board. If the clip is of the through-hole variety as shown in FIGS. 2-2c, the legs 210 will be placed through holes resident on the printed circuit board and will be secured via wave soldering, hand soldering, or other common through-hole mounting techniques. If the clip is of the surface mount variety, such as that shown in FIGS. 4-4a, 5, then the clips will be placed on the printed circuit board onto screen printed solder paste and will be subsequently reflowed in place. Moreover, compliant non-solderable attachment techniques can be used (e.g., the aforementioned “eye of the needle” approach, etc.).

It can be appreciated that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A clip apparatus having a unitary construction for attaching a structure to a substrate, comprising:
a closed entry structure receiving element, said component receiving element comprising at least one lead-in feature;
at least one terminating element, said terminating element adapted to interface said clip apparatus to said substrate;
a spring clip element; and
an overstress feature, said overstress feature adapted to prevent said spring clip element from becoming overstressed;
wherein said spring clip element is formed from material originally adjacent said at least one terminating element.

2. The clip apparatus of claim 1, wherein said at least one terminating element comprises two terminating elements, and said spring clip element is formed from material originally disposed between said two leads.

3. The clip apparatus of claim 2, further comprising a support feature, said support feature disposed proximate said structure receiving element and adapted to prevent said structure receiving element from deforming during structure insertion.

4. The clip apparatus of claim 3, wherein said support feature comprises two elements deformed to engage respective distal portions of said closed entry receiving element.

5. The clip apparatus of claim 3, further comprising a carrier, said carrier comprising a plurality of indexing holes and adapted to be detachably connected to at least a portion of said clip apparatus.

6. The clip apparatus of claim 4, wherein said structure comprises an automotive blade fuse.

7. The clip apparatus of claim 1, wherein said at least one terminating element comprises at least one surface mounted lead.

8. The clip apparatus of claim 1, wherein said at least one terminating element comprises two substantially parallel through-hole leads.

9. The clip apparatus of claim 7, further comprising a carrier, said carrier comprising a plurality of indexing holes and adapted to be detachably connected to at least a portion of said clip apparatus.

10. The clip apparatus of claim 9, wherein said structure comprises an automotive blade fuse.

11. The clip apparatus of claim 1, further comprising a second substantially identical clip apparatus, said two clip apparatus being disposed with respect to another component at a pitch corresponding to that of the pitch of a two-terminal fuse, said disposition of said two clip apparatus permitting substantially simultaneous insertion of said fuse into said two clip apparatus.

12. The clip apparatus of claim 11, wherein said another component is selected from the group consisting of: (i) a printed circuit board; and (ii) a plastic housing.

13. The clip apparatus of claim 1, wherein said spring clip element comprises a bend, said bend forming a contact point for contacting said structure, said bend also causing a portion of said spring clip element to contact said overstress feature when said structure is inserted into said clip apparatus.

14. The clip apparatus of claim 13, wherein said contact point is disposed at a location relative to said closed entry element in order to mitigate rotation of said structure within said clip apparatus.

15. The clip apparatus of claim 1, wherein said spring clip element comprises:
a first bend, said first bend forming a first contact point for contacting a first point of said structure; and
a second bend, said second bend forming a second contact point for contacting a second point of said structure;
wherein said first and second contact points are disposed at different locations along a longitudinal axis of said structure when said structure is received within said clip apparatus.

16. Socket apparatus, comprising a unitary metallic structure adapted to receive a terminal of a fuse, said socket apparatus further comprising an overstress feature adapted to prevent damage to a resilient arm of said socket apparatus as a result of the insertion of said fuse clip;
wherein said resilient arm and said overstress feature are each formed through deformation of a portion of a substantially planar metallic plate.

17. The socket apparatus of claim 16 further comprising a plurality of through-hole terminating leads.

18. The socket apparatus of claim 17 further comprising a carrier element.

19. The socket apparatus of claim 16 further comprising a closed-entry feature that assures both (i) proper location of said fuse terminal for insertion; and (ii) proper orientation of said fuse terminal.

20. The socket apparatus of claim 19, wherein said closed entry feature comprises a section of said unitary metallic section having a cavity and a plurality of lead-in features adapted to guide said fuse terminal upon insertion.

21. The socket apparatus of claim 16 further comprising surface mount terminating leads.

22. The socket apparatus of claim 16, wherein said resilient arm comprises a bend, said bend forming a contact point for contacting said terminal, said bend also causing a portion of said arm to contact said overstress feature when said terminal is inserted into said socket apparatus.

23. The socket apparatus of claim 22, wherein said contact point is disposed at a location selected at least to mitigate rotation of said fuse within said socket apparatus.

24. The socket apparatus of claim 17, wherein said plurality of terminating leads comprises two terminating leads, and said resilient arm is formed from material originally disposed between said two leads.

25. A method of making a socket apparatus, comprising:
providing a metallic material comprising a substantially planar configuration; and
processing said metallic base material using a stamping process, said act of processing forming said socket apparatus, said socket apparatus comprising:
a unitary metallic element adapted to receive a structure, said socket apparatus further comprising an overstress feature adapted to prevent damage to a resilient arm of said socket apparatus as a result of the insertion of said structure;
wherein said forming of said socket apparatus comprises deforming said substantially planar metallic material at a plurality of locations on said planar material.

26. The method of claim 25, further comprising a plating process, said plating process occurring after said act of processing.

27. The method of claim 25, further comprising a plating process, said plating process occurring before said act of processing.

28. The method of claim 25, wherein said deforming comprises forming two terminating elements, said terminating elements adapted to terminate said socket apparatus to a printed circuit board.

29. The method of making a clip apparatus of claim 28, wherein said terminating elements comprise through-hole leads.

30. A method of making an electrically conductive and unitary socket, comprising:
providing a substantially planar metallic element;
stamping portions of said element to form:
a plurality of separated regions, said separated regions comprising two terminals and a central contact arm disposed substantially between said two terminals; and
an entry feature having an aperture formed therein;
deforming said contact arm out of the plane of said element into a substantially resilient shape; and
deforming said entry feature out of the plane of said element so that at least a portion of said entry feature acts to limit the outward travel of said resilient contact arm during insertion of a component terminal into said socket.

31. The method of claim 30, further comprising:
stamping portions of said element to form two lateral supports; and
deforming said two lateral supports out of said plane of said element to engage respective portions of said entry feature so as to support said entry feature during insertion of said component terminal into said socket.

32. The method of claim 31, wherein said act of stamping to form an entry feature comprises stamping to form two guide features proximate said aperture; and
deforming said two guide features into a shape that aids in properly guiding said component terminal into said aperture during said insertion.

33. A method of using a socket apparatus, comprising:
providing a socket apparatus comprising a unitary metallic structure adapted to receive a terminal of another apparatus in an aperture of said structure, said socket apparatus further comprising a protective feature adapted to prevent damage to a resilient arm of said socket apparatus as a result of the insertion of said terminal;
inserting said terminal into said aperture of said structure in an improper manner;
deflecting said resilient arm using at least said terminal; and
utilizing a protective feature during said deflecting, said protective feature protecting at least said resilient arm.

34. The method of claim 33, wherein said act of inserting in an improper manner comprises inserting at a substantially oblique angle relative to a plane of said aperture.

35. The method of claim 33, wherein said act of inserting in an improper manner comprises applying an excessive force normal to a plane of said aperture during said insertion.

36. The method of claim 33, wherein said act of inserting in an improper manner comprises inserting a terminal which is oversized for said structure.

37. The method of claim 33, wherein said act of utilizing a protective feature comprises stopping said deflecting of said resilient arm at a prescribed point of travel to prevent over-stress of said arm.
